(19) United States
(12) Patent Application Publication
(10) Pub. No.: US 2004/0263346 A1
(43) Pub. Date: Dec. 30, 2004

(54) Solid state adaptive forward lighting system

(75) Inventor: Craig J. Neal, Indianapolis, IN (US)

Correspondence Address: RUSSELL E. FOWLER, II, ICE MILLER, ONE AMERICAN SQUARE, BOX 82001, INDIANAPOLIS, IN, 46282-0002, US

(73) Assignee: Guide Corporation, A Delaware Corporation, Pendleton, IN

(21) Appl. No.: 10/609,200

(22) Filed: Jun. 27, 2003

(51) Int. Cl. G08B 5/22

(52) U.S. Cl. 340/815.45; 362/465

(57) ABSTRACT

A solid state adaptive forward lighting system is described for use with automobile headlamps. A central processing unit receives input from automobile wheel position sensors and incline sensors. The processing unit signals an array of light emitting diodes to selectively operate one or more diodes in the array to produce light. The array of light emitting diodes is provided with a converging lens to selectively change the angle of light projected from the light housing. The invention is thus able to change the angle of light based on the inputs from the sensors. The change in the angle of light enhances the automobile operator's view of the upcoming roadway, regardless of the orientation of the vehicle.

### BACKGROUND

An adaptive forward lighting system (“AFS”) is a system in which an automobile headlamp may selectively alter the beam pattern projected, to anticipate the direction of the automobile. The AFS contrasts with a fixed headlamp system, in which the headlamp is operable only to project light in a forward direction.

The AFS is useful to the automobile operator, as it changes the beam pattern with road conditions and automobile motion, to continually project light onto the roadway ahead of the automobile, regardless of whether the automobile is turning or is traveling up or down a sloped road. Consequently, the automobile operator may have a greater awareness of the roadway ahead of them, and may thus be able to more accurately anticipate obstacles or other problems in the upcoming roadway. By angling the beam pattern either up or down, the AFS is able to project light a constant distance from the automobile, even while the automobile chassis pitch varies relative to the suspension. A traditional fixed headlamp, by comparison, is only able to project light along a specific angle, limiting the amount of light striking the roadway when the vehicle is out of a level plane. Further, the AFS is able to continually follow the upcoming roadway while a vehicle is turning. Thus, the headlamps illuminate the roadway where the automobile operator needs to see. A traditional fixed headlamp simply projects light tangentially to the turning automobile, making it difficult for the automobile operator to see “into” the turn.

Unfortunately, current AFS typically utilizes a single point light source. The single point light source or the lens in front of the light source is then moved mechanically in order to project light in the desired direction. The mechanical movements are prone to failure, and are costly to manufacture and install. A significant amount of electricity is also required for the mechanical movements, where the availability of electricity is limited.

A substantial improvement, then, would incorporate solid state electronics into the AFS, replacing the mechanical movements. Such a system would be less costly to manufacture, easier to install and maintain, would have a longer expected lifetime, and would require less electricity than current a current AFS using mechanical movements.

### SUMMARY

A solid state adaptive forward lighting system comprises an array comprising a plurality of light emitting diodes attached to the array. The array is positioned within a housing, and a condensing lens is positioned in front of the array and the housing. A controller is in communication with the array, and is thereby in communication with each of the plurality of light emitting diodes attached to the array. A wheel angle sensor and an incline sensor are in communication with the controller, and relate information regarding the direction of travel and the front-to-back tilt of the automobile, respectively. The controller interprets the communication from the wheel angle sensor and the incline sensor, and selectively illuminates one or more of the plurality of light emitting diodes attached to the array, defining a pattern of a light source. When the controller interprets that the automobile has changed direction or incline, the controller is operable to selectively illuminate additional light emitting diodes on the array adjacent to the light source, and de-energize, or extinguish, the same number of light emitting diodes that are a part of the light source. In this manner, the controller is operable to change the position of the light source on the array, to follow the direction of travel or the incline of the automobile.

These and other advantages and features of the present invention shall hereinafter appear, and for the purposes of illustration, but not limitation, exemplary embodiments of the present invention shall hereinafter be described.

### BRIEF DESCRIPTION OF THE DRAWINGS

FIG. 1 is side cross sectional view of an embodiment of an adaptive forward lighting system in accordance with the present invention;

FIG. 2 is a component view of the adaptive forward lighting system of FIG. 1;

FIG. 3 is an electrical diagram of the array of the adaptive forward lighting system of FIG. 1;

FIG. 4 is an exemplary lighted pattern of light emitting diodes of the array along line A-A of the adaptive forward lighting system of FIG. 1; and

FIG. 5 is a side cross sectional view of the adaptive forward lighting system of FIG. 1, showing exemplary light beams.

### DETAILED DESCRIPTION

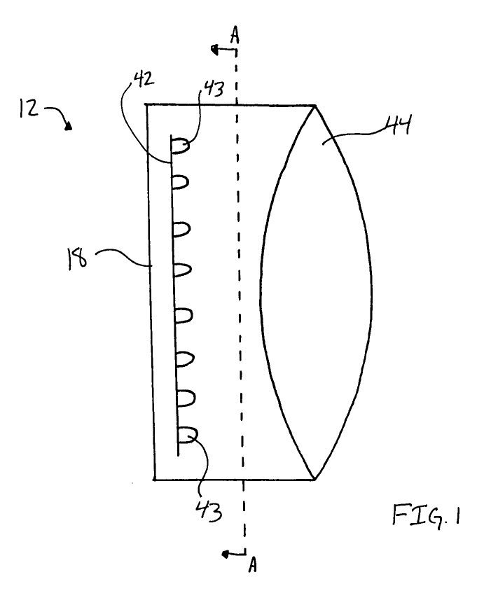

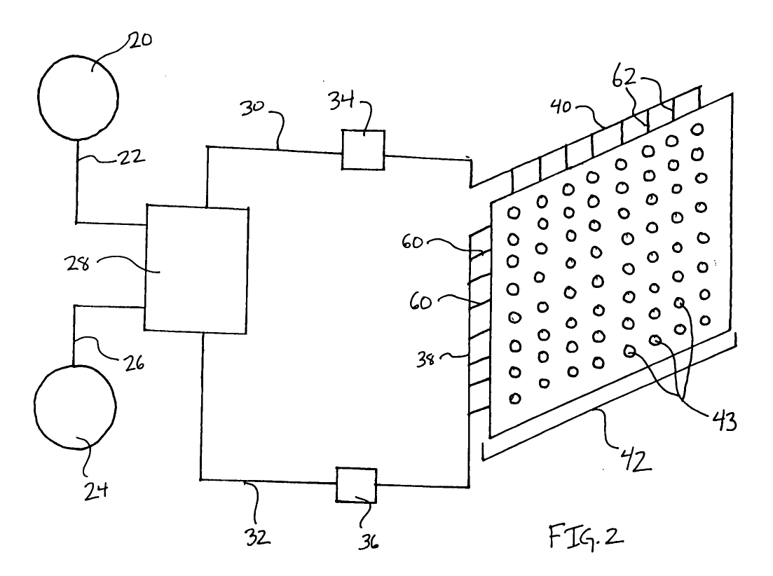

A solid state adaptive forward lighting system (“AFS”) is provided as shown in FIGS. 1 and 2, and is generally indicated as numeral 12. With reference to FIGS. 1 and 2, a solid state AFS 12 comprises an array 42 of light emitting diodes (“LEDs”) 43 positioned within a housing 18. Each row of the array 42 is electrically connected to a horizontal LED driver 36, and each column of the array 42 is electrically connected to a vertical LED driver 34. The horizontal and vertical drivers 36 and 34 are attached to a central processing unit 28. A wheel angle sensor 20 and an incline sensor 24 are both attached to the central processing unit 28. A converging lens 44 is positioned in front of the array 42. Upon receiving signals from the wheel angle sensor 20 and the incline sensor 24, the central processing unit 28 communicates with the horizontal and vertical LED drivers 36 and 34, to illuminate selected LEDs 43 in the array 42. Light rays from the LEDs 43 are angled by the lens 44, such that the selective illumination of one or more of the LEDs 43 in the array 42 allows the headlamp to project light in variable horizontal and vertical directions.

The wheel angle sensor 20 detects the amount of rotation of the automobile's steering wheel. The rotation of the steering wheel is useful in gauging the direction of the automobile. The wheel angle sensor 20 is in communication with the central processing unit 28 via wire 22.

The incline sensor 24 detects the front-to-back tilt of the automobile. The tilt of the automobile is useful in determining the type and amount of headlamp correction needed while the automobile is situated in a positive or negative slope, such as a hill or a valley. The incline sensor 24 is in communication with the central processing unit 28 via wire 26. It should be noted that both the wheel angle sensor 20 and the incline sensor 24 may provide output via either a digital or an analog signal. If one or both of the sensors created an analog signal, it would be necessary to use one or more analog to digital converters to change the analog signal into a digital signal, as the central processing unit 28, in the current embodiment, utilizes a digital signal to gather input from the sensors. Also, both sensors may be operable to sample at any frequency. Both the wheel angle sensor 20 and the incline sensor 24 may also be integrated into the central processing unit 28, to provide a single element to sense the orientation of the automobile and selectively operate the array 42. Optionally, additional sensors may be used to monitor and communicate other automobile characteristics relevant to the operation of the AFS 12. For example, a speed sensor may be employed to monitor the automobile's speed. This additional information may be communicated to the central processing unit 28, and may be used to vary the array 42.

The central processing unit 28 receives input from the wheel angle sensor 20 and the incline sensor 24. Based on these input streams, output is sent to the vertical LED driver 34 and the horizontal LED driver 36. The central processing unit 28 may be a computerized electric circuit as well known in the art, or may be some other form of circuit which is able to receive input from sensors and is able to output signals based on the input signals. The central processing unit 28 may optionally be a single computer system, where the output to the vertical LED driver 34 and the horizontal LED driver 36 is found in computer software associated with the central processing unit 28. Components used to operate the computer software with the central processing unit 28 are not shown and are well known and practiced in the art.

The vertical LED driver 34 is in communication with the central processing unit 28 via wire 30. The vertical LED driver 34 may be an electric circuit well known in the art. The vertical LED driver 34 is operable to energize one or more rows of LEDs 43 attached to the array 42.

The horizontal LED driver 36 is also in communication with the central processing unit 28 via wire 32. The horizontal LED driver 36 may be an electric circuit well known in the art. The horizontal LED driver 36 is operable to energize one or more columns of LEDs 43 attached to the array 42. It should be noted that both the vertical LED driver 34 and the horizontal LED driver 36 may be integrated into the central processing unit 28, or may be discrete components.

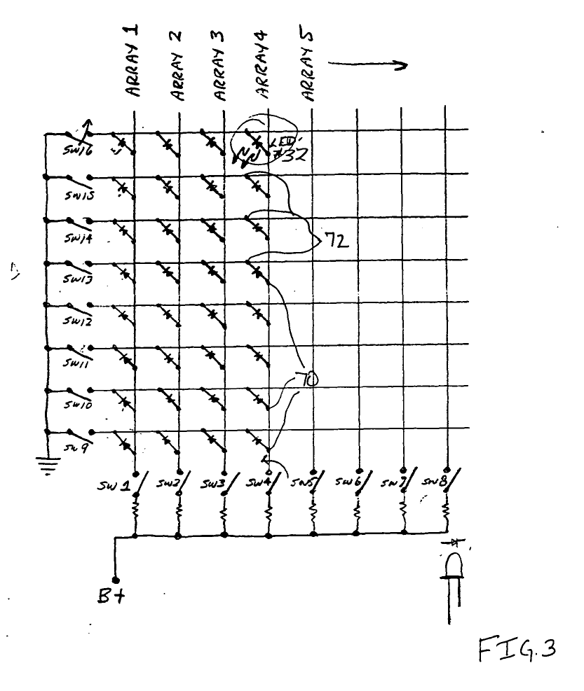

The array 42 is deposited within the cavity of the housing 18. With reference to FIGS. 2 and 3, the array 42 comprises a circuit board having one or more vertical lines 62 and one or more horizontal lines 60. Both the vertical lines 62 and the horizontal lines 60 are comprised of electrically conductive material, such that the lines 60 and 62 conduct electricity along the circuit board. The vertical lines 62 are parallel to one another and are arranged vertically on the circuit board. The horizontal lines 60 are parallel to one another and are arranged horizontally on the circuit board, such that the vertical lines 62 and the horizontal lines 60 intersect each other at ninety degree angles. Where the vertical lines 62 and the horizontal lines 60 intersect, an insulating material is placed between the lines so that the lines are not in electrical communication. Near each intersection point, a LED bulb 43 is connected between lines 60 and 62. Each LED is connected by a vertical lead 70 connected to one of the vertical lines 60 and a horizontal lead 72 connected to one of the horizontal lines 60. Although FIGS. 2-4 show an 8×8 array 42 of LED bulbs 43, neither the figures nor the descriptive operation is intended to limit the array 42 to such dimensions or to a substantially square shape. Indeed, the array 42 may be any size or shape necessary to provide adequate illumination patterns. Each of the horizontal lines 60 and vertical lines 62 terminate into a horizontal bus 38 and a vertical bus 40, respectively. The horizontal bus 38 is in electrical communication with the horizontal LED driver 36, and the vertical bus 40 is in electrical communication with the vertical LED driver 34. As shown in FIG. 3, each of the horizontal lines 60 and vertical lines 62 terminates in an associated switch, which is operable by the horizontal LED driver 36 and the vertical LED driver 34, respectively.

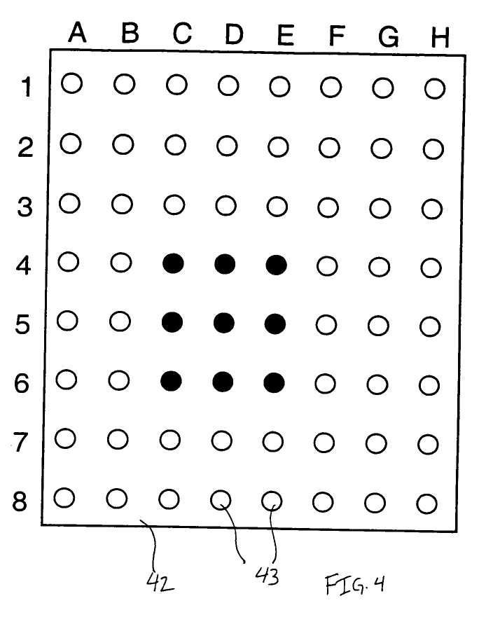

Individual LEDs are illuminated in the array when each switch connected to the LED's leads are closed, thereby allowing electric current to flow through and energize the LED. For example, in order to illuminate LED C2, as shown in FIG. 4, the switch for the “C” column and the switch for the “2” row would be closed by the horizontal LED driver 36 and the vertical LED driver 34, respectively.

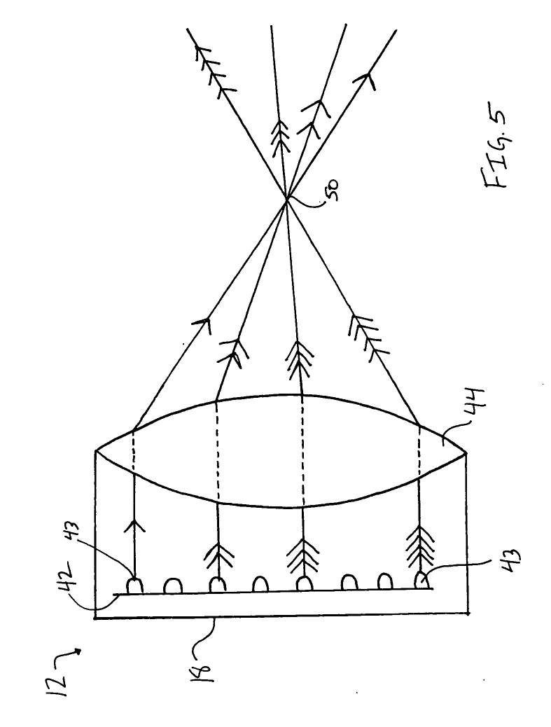

The housing 18 forms an interior surface, an exterior surface, and a housing opening. The lens 44 is positioned over the housing opening and sealed to the housing 18, thereby enclosing the interior of the housing 18. The seal may be accomplished in any of a number of ways well known in the art. The lens 44 is a converging lens manufactured from a transparent material. The converging lens 44 serves to focus or angle emitted light rays and has properties and characteristics that are well known in the art. As shown in FIG. 5, the converging lens 44 focuses the light from each of the LEDs 43 to a focal point 50, where the light then spreads out in divergent directions. It should be noted that the focal point 50 may be at any length from the converging lens 44, and that the size or the shape of the lens 44 may be different than exemplary FIG. 5. The lens 44 may optionally be made from a material which allows light of a certain wavelength or range of wavelengths to pass, therefore imparting a distinct color to light radiated outside of the cavity. While the housing 18 is shown to be semi-circular, it should be recognized that the housing 18 can be formed in any desired shape and the interior surface can be formed to focus reflected light rays in any desired pattern.

Operation of the disclosed embodiment of a solid state adaptive forward lighting system is now described with reference to FIGS. 1-5.

The wheel angle sensor 20 tracks the rotation of the automobile's steering wheel, and communicates the information to the central processing unit 28 via wire 22. The incline sensor 24 tracks the front-to-back inclination of the automobile, and communicates the information to the central processing unit 28 via wire 26. The central processing unit 28 receives the information from the wheel angle sensor 20 and the incline sensor 24, and based on this information, formulates an appropriate LED pattern for illumination. An example of the operation of the system will be conducted with the wheel angle sensor 20 communicating a level steering wheel to the central processing unit 28, and the incline sensor 24 communicating a level automobile body to the central processing unit 28. Of course, either the wheel angle sensor 20 or the incline sensor 24 may communicate any angle of the steering wheel or the automobile body. Receiving communications relating to a level steering wheel and a level automobile body causes the central processing unit 28 to communicate with the horizontal LED driver 36 and the vertical LED driver 34 to create an illuminated LED pattern in or near the center of the array 42. The central processing unit 28 communicates information to the vertical LED driver 34 regarding the columns to energize, and also communicates information to the horizontal LED driver 36 regarding the rows to energize. The vertical LED driver 34 and the horizontal LED driver 36 thus operate on the vertical bus and the horizontal bus, to selectively energize specific vertical lines and horizontal lines, respectively. A LED 43 is illuminated only if both the attached vertical line 62 and the horizontal line 60 are energized by closing the switch associated with each line. As an example, LED C4 in FIG. 4 is only energized if the horizontal line 60 depicted as row “4” in this example, and the vertical line 62 depicted as “C” in this example, are energized.

FIG. 4 shows an exemplary 8×8 array 42 of LED bulbs, and a pattern of LED illumination according to the inputs received from the wheel angle sensor 20 and the incline sensor 24 as described above. Illuminated LED bulbs are depicted as shaded circles, and non-illuminated LED bulbs are depicted as empty circles. Each row of LED bulbs is given an identification number, and each column is given an identification letter. Each LED bulb may thus be identified by the combination of the column identifier and the row identifier. For example, the LED bulb in the upper left of the array 42 is denoted as LED A1, and the LED bulb in the lower right of the array 42 is denoted as LED H8. The illuminated LEDs 43 depicted in FIG. 3 are C4, C5, C6, D4, D5, D6, E4, E5, and E6. Illumination of a number of adjacent LEDs 43 is typically required to produce a beam pattern.

If, in the above example, the wheel angle sensor 20 communicates to the central processing unit 28 that the automobile steering wheel has turned to the left (with respect to the driver), it would be advantageous to move the pattern of illuminated LEDs 43 in the array 42 to illuminate the roadway to the left. The central processing unit 28 thus communicates with the vertical LED driver 34 to energize exemplary column “B,” as shown in FIG. 4, and de-energize exemplary column “E.” If the wheel angle sensor 20 detects that the steering wheel has turned to the left even more, the central processing unit 28 may also operate the vertical LED driver 34 to energize exemplary column “A,” and de-energize or extinguish exemplary column “D.” Thus, the total number of illuminated LED bulbs 43 remains constant, and adjacent LEDs 43 remain illuminated, but the position of the illuminated pattern shifts across the array 42. It should be noted that the use of a converging lens 44 condenses light rays to a focal point, and then spreads the light rays out, so that illumination of columns denoted as “A” and “B” in FIG. 4 creates a beam of illumination to the left of the automobile (with respect to the driver). The converse may be applied to illuminate the roadway to the right, should the wheel angle sensor 20 communicate to the central processing unit 28 that the automobile steering wheel has turned to the right (i.e. columns “F,” “G,” and “H” could be switched on sequentially as the driver turns the steering wheel further to the right).

Similarly, if the incline sensor 24 communicates to the central processing unit 28 that the automobile body is tilting upward (i.e., has a positive slope with respect to the ground slope), it would be advantageous to move the pattern of illuminated LEDs 43 in the array 42 down, in order to fully illuminate the upcoming roadway. The central processing unit 28 thus communicates with the horizontal LED driver 36 to energize exemplary row “3,” as shown in FIG. 4, and de-energize exemplary row “6.” If the incline sensor 24 detects that the automobile body is tilted even further upward, the central processing unit 28 may also operate on the horizontal LED driver 36 to energize exemplary row “2,” and de-energize exemplary row “5.” The converse may be applied to angle the projected beam upwardly, should the incline sensor 24 communicate to the central processing unit 28 that the automobile body is tilted downward.

Of course, both the wheel angle sensor 20 and the incline sensor 24 may communicate changes to the central processing unit 28 simultaneously. The pattern of illuminated LED bulbs 43 may be adjusted in any direction on the array 42, including vertically, horizontally, or diagonally. Also, in a particularly sharp turn or sudden change in automobile slope, the central processing unit 28 may operate on the array 42 to change the pattern of illuminated LED bulbs 43 from one position to another position, instead of moving the pattern by one column or one row at a time. Further, it is considered that the central processing unit 28 may operate on the array 42 to change the size and/or shape of the pattern of illuminated LED bulbs 43, to increase or decrease the total amount of light emitted from the housing. For example, the array could be changed to provide side lighting in addition to standard forward lighting. As another example, the array could be changed to provide high beam lighting in addition to standard low beam lighting.

As can be readily seen, the present invention of utilizing an array of LED bulbs for the purpose of altering headlamp beam orientation eliminates the need for mechanical movement of the light source or the lens. Eliminating the mechanical movement reduces electrical requirements, and also eliminates moving parts. Utilizing the present invention with an automobile decreases the electrical demands and increases the useful life of the headlamp.

Although other advantages may be found and realized and various modifications may be suggested by those versed in the art, it is understood that the present invention is not to be limited to the details given above, but rather may be modified within the scope of the appended claims.

I claim:

1. A solid state adaptive forward lighting system comprising:
a. an LED array comprising a plurality of light emitting diodes, the plurality of light emitting diodes forming a plurality of rows and a plurality of columns in the LED array;
b. a controller connected to the LED array, the controller operable to selectively illuminate light emitting diodes on the LED array, the illuminated light emitting diodes thereby defining a light source; and
c. at least one sensor for communicating the automobile's orientation to the controller, the controller further operable to move the light source within the LED array based on the input from the at least one sensor, the controller selectively illuminating a number of light emitting diodes adjacent to the light source and extinguishing an equal number of light emitting diodes included in the light source to effectively move the light source within the LED array.

2. The solid state adaptive forward lighting system of claim 1, where the at least one sensor comprises a wheel angle sensor, operable to determine the position of the automobile steering wheel, and an incline sensor, operable to determine the slope of the automobile.

3. The solid state adaptive forward lighting system of claim 1, where the LED array is comprised of at least one horizontal lead line and at least one vertical lead line, with each of the at least one light emitting diodes attached to one horizontal lead line and one vertical lead line

4. The solid state adaptive forward lighting system of claim 3, where the controller comprises a vertical LED driver in communication with the at least one vertical lead line and a horizontal LED driver in communication with the at least one horizontal lead line.

5. The solid state adaptive forward lighting system of claim 1, further comprising a converging lens positioned in front of the LED array.

6. The solid state adaptive forward lighting system of claim 1, where the at least one light emitting diode is arranged in a row and column arrangement on the LED array, where the controller is in individual communication with each of the at least one light emitting diode.

7. The solid state adaptive forward lighting system of claim 1, where the pattern of illuminated light emitting diodes is a constant shape.

8. The solid state adaptive forward lighting system of claim 1, where the pattern of illuminated light emitting diodes is variable.

9. A solid state adaptive forward lighting system comprising:
a. an LED array comprising a plurality of light emitting diodes, the plurality of light emitting diodes forming a plurality of rows and a plurality of columns in the LED array, the LED array further comprising a plurality of switches and each of the plurality of rows and plurality of columns associated with one of the plurality of switches;
b. a controller connected to the LED array, the controller operable to open or close each of the plurality of switches and thereby selectively illuminate light emitting diodes on the LED array, the illuminated light emitting diodes thereby defining a light source;
c. at least one sensor for communicating the automobile's orientation to the controller, the controller further operable to move the light source in the LED array by selectively opening and closing selected switches from the plurality of switches.

10. The solid state adaptive forward lighting system of claim 9, where the at least one sensor comprises a wheel angle sensor, operable to determine the position of the automobile steering wheel, and an incline sensor, operable to determine the slope of the automobile.

11. The solid state adaptive forward lighting system of claim 9, further comprising a converging lens positioned in front of the LED array.

12. The solid state adaptive forward lighting system of claim 9, where the number of illuminated light emitting diodes is constant, and where the pattern of illuminated light emitting diodes is a constant shape.

13. The solid state adaptive forward lighting system of claim 9, where the number of illuminated light emitting diodes is variable.

14. The solid state adaptive forward lighting system of claim 9, where the pattern of illuminated light emitting diodes is variable.

15. A solid state adaptive forward lighting system comprising:
a. an LED array comprising a plurality of light emitting diodes, the plurality of light emitting diodes forming a plurality of rows and a plurality of columns in the LED array;
b. a controller connected to the LED array, the controller operable to selectively illuminate light emitting diodes on the LED array, the illuminated light emitting diodes thereby defining a light source; and
c. at least one sensor for communicating the automobile's orientation to the controller, the controller further operable to move the light source within the LED array based on the input from the at least one sensor; and
d. a converging lens positioned in front of the LED array.

16. The solid state adaptive forward lighting system of claim 15, where the at least one sensor comprises a wheel angle sensor, operable to determine the position of the automobile steering wheel, and an incline sensor, operable to determine the slope of the automobile.

17. The solid state adaptive forward lighting system of claim 15, where the LED array is comprised of at least one horizontal lead line and at least one vertical lead line, with each of the at least one light emitting diodes attached to one horizontal lead line and one vertical lead line

18. The solid state adaptive forward lighting system of claim 17, where the controller comprises a vertical LED driver in communication with the at least one vertical lead line and a horizontal LED driver in communication with the at least one horizontal lead line.

19. The solid state adaptive forward lighting system of claim 15, where the number of illuminated light emitting diodes is constant, and where the pattern of illuminated light emitting diodes is a constant shape.

20. The solid state adaptive forward lighting system of claim 15, where the number of illuminated light emitting diodes is variable.

21. The solid state adaptive forward lighting system of claim 15, where the pattern of illuminated light emitting diodes is variable.

22. A method of adjusting a light beam emitted from an automobile headlamp comprising:
a. providing an LED array including a plurality of light emitting diodes, the plurality of light emitting diodes forming a plurality of rows and a plurality of columns in the LED array;
b. providing a controller connected to the LED array, the controller operable to selectively illuminate light emitting diodes on the LED array, the illuminated light emitting diodes thereby defining a light source;
c. providing at least one sensor for communicating the automobile's orientation to the controller;
d. transmitting data concerning an automobile's orientation from the at least one sensor to the controller;
e. moving the light source within the LED array by selectively illuminating a number of light emitting diodes adjacent to the light source while extinguishing an equal number of light emitting diodes included in the light source.

23. The method of claim 22, where the at least one sensor comprises a wheel angle sensor, operable to determine the position of the automobile steering wheel, and an incline sensor, operable to determine the slope of the automobile.

24. The method of claim 22, where the LED array is comprised of at least one horizontal lead line and at least one vertical lead line, with each of the at least one light emitting diodes attached to one horizontal lead line and one vertical lead line

25. The method of claim 24, where a vertical LED driver is in communication with the at least one vertical lead line and a horizontal LED driver is in communication with the at least one horizontal lead line.

26. The method of claim 22, further comprising a converging lens positioned in front of the LED array.

27. The method of claim 22, where the pattern of illuminated light emitting diodes is a constant shape.

28. The method of claim 23, where the pattern of illuminated light emitting diodes is variable.
